(19) United States
(12) Patent Application Publication
(10) Pub. No.: US 2009/0251670 A1
(43) Pub. Date: Oct. 8, 2009

(54) OPTICAL FEEDBACK FOR HIGH SPEED SCAN MIRROR

(75) Inventors: Miklos Stern, Woodmere, NY (US); Chinh Tan, Setuaket, NY (US); Dmitriy Yavid, Stony Brook, NY (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/061,852

(22) Filed: Apr. 3, 2008

(51) Int. Cl. G03B 21/28; G01B 11/02

(52) U.S. Cl. 353/98; 356/498

(57) ABSTRACT

An image projection system (100) has a laser (102, 104, 106) providing at least one beam (103, 105, 107) to a scan mirror apparatus (130) for scanning the at least one beam (103, 105, 107) in two orthogonal directions (404, 406). The scan mirror (130) includes an oscillating portion (204, 904) disposed contiguous to a frame (202) and includes a reflective portion (218, 918) capable of reflecting the beam (103, 105, 107). A light source (502, 602, 702, 802) provides light to the scan mirror (130); and circuitry analyzing the light reflected to determine the position of the oscillating portion (204).

### FIELD

The present invention generally relates to laser beam image projection devices, and more particularly to an apparatus for providing feedback describing the position of a scan mirror.

### BACKGROUND

It is known that two-dimensional images may be projected onto a screen by reflecting a laser beam or beams off of an oscillating scan mirror to project a raster pattern including scan lines alternating in direction, for example, horizontally across the screen, with each scan line being progressively displaced vertically on the screen. The laser beam or beams are selectively energized to illuminate pixels on the screen, thereby providing the image.

A first scan mirror typically oscillates at a high speed back and forth horizontally while a second scan mirror oscillates at a lower speed vertically. The first scan mirror oscillates at a resonance frequency with the highest velocity in the center while approaching zero as it nears either extreme of its oscillation. The second mirror moves at a constant speed in the orthogonal direction (vertically) from the top of the screen to the bottom, for example, then returns to the top for the next frame of the image.

The repetitive oscillation or movement of the mirrors is caused by a drive apparatus for each mirror. Conventional mirror systems include a permanent magnet or a piezoelectric device mounted on each mirror with a drive signal applied to a coil or directly to the piezoelectric device, thereby providing motion to the mirror. A processor providing the drive signal determines the timing at which the lasers must be pulsed to match the angular deflection at which the mirrors are driven, in a synchronous fashion, to illuminate the appropriate pixel.

In order for the processor to make an accurate determination of the position of the mirror or mirrors for coordinating the laser beam pulses to improve image convergence between the alternating scans, feedback of the mirror's position is provided to the processor so the laser pulses may be appropriately timed. One known method of providing this feedback is to mount a magnet on the mirror, which creates a changing magnetic field as the mirror is scanning. The changing electric current generated in an external coil provides the feedback indicating the velocity of the scan mirror. The position can in turn be deduced form this signal. However, mounting a magnet on the mirror increases the mirror's inertia, and in turn, the size of the entire mirror structure.

Accordingly, it is desirable to provide an apparatus for providing feedback of the mirrors position to improve image convergence without increasing the mass of the mirror. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a top view of a known image projection system;

FIG. 2 is a side view of a known scan mirror for use in the image projection system of FIG. 1;

FIG. 3 is a perspective front view of a known inertial drive for use with the scan mirror of FIG. 2;

FIG. 4 is a projection of an image showing scan lines provided from the system of FIG. 1;

FIG. 5 is an apparatus providing optic feedback in accordance with a first exemplary embodiment;

FIG. 6 is an apparatus for providing optic feedback in accordance with a second exemplary embodiment;

FIG. 7 is an apparatus for providing optic feedback in accordance with a third exemplary embodiment;

FIG. 8 is an apparatus for providing optic feedback in accordance with a fourth exemplary embodiment;

FIG. 9 is a top view of an apparatus for providing optic feedback in accordance with a fourth exemplary embodiment; and

FIG. 10 is a side view of the fourth exemplary embodiment of FIG. 9.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An image projection system includes a pulsed light source, for example, red, green, and blue lasers, and a mirror system including a first oscillating reflective surface for generating an image comprised of scanned lines. The mirror includes a moveable frame (on the order of a few microns) and an oscillating reflective surface disposed contiguous thereto. In order to synchronize the pulsed light and the positioning of the mirror, optical feedback is obtained that indicates the position of the mirror. An optical source is disposed to reflect light off of the mirror system, wherein the reflected light is analyzed to determine the position of the mirror. A first embodiment is a laser providing a first beam that is reflected off of the mirror and a second beam that is reflected off of an object stationary to the laser. An interferometer system analyzes the first and second beams to determine the position of the mirror at any specific point in time. A second embodiment is a laser providing a beam that is reflected off an optically rough surface on the backside of the mirror that creates a speckle pattern on one or more photodetectors. The changing of the light intensity (speckle pattern) is correlated with the movement of the scan mirror. A third embodiment involves a laser providing a beam that is reflected off a plurality of grooves on the mirror system, thereby creating a diffraction pattern allowing for a high resolution detection of the mirror position. A fourth embodiment involves a broadband light source, for example, a light emitting diode, emitting light upon a diffraction grating on the mirror system resulting in the broadband light being scattered in different directions as a function of wavelength. Several detectors collect several signals simultaneously from which the position of the reflective surface may be obtained. The reflective front surface of the mirror is used to project the image to a projection surface. The backside of the mirror is preferably used to obtain the feedback signal. This is true for the last three approaches mentioned above, where the back surface is rough or regularly grooved. Even with the first method, it is practically easier to place the feedback apparatus (light source and detector) behind the mirror. If it were placed in the front of the mirror, it would be difficult making sure that the components of the feedback system do not block the projection beam.

Furthermore, a light source that is tightly focused, in combination with a detector that has a very small aperture could be used. A good signal could be obtained when the beam passes through the aperture, giving a good indication of the mirror position after calibration.

Referring to FIG. 1, a projection system 100 includes three lasers 102, 104, 106 for emitting a beam of different frequencies. Laser 102 preferably is a semiconductor laser emitting a red beam 103 at about 635-655 nanometers. Lens 110 is a biaspheric convex lens having a positive focal length and is operative for collecting virtually all the energy in the read beam 103 and for producing a diffraction-limited beam with a focus at a specified distance from the lens.

The laser 104 preferably is a semiconductor laser emitting a blue beam 105 at about 475-505 nanometers. Another biaspheric convex lens 112 shape the blue beam 105 in a manner analogous to lenses 110 shaping the red beam 103.

Laser 106 is preferably a laser system including an infrared semiconductor laser having an output beam of 1060 nanometers, and a non-linear frequency doubling crystal. An output mirror (not shown) of the laser 106 is reflective to the 1060 nanometer infrared radiation, and transmissive to the doubled 530 nanometer green laser beam 107. One or more lenses, for example a biaspheric convex lens 114, may be used to create the desired beam 107 shape. While lasers 102 and 104 are described as semiconductor lasers and laser 106 is described as a laser system, it should be understood that any type of laser may be used for any of the three beams 103, 105, 107.

The laser beams 103, 105, 107 are pulsed at frequencies on the order of 100 MHz. The green beam 107 is reflected off of mirror 122 towards the scanning assembly 130. Dichroic filters 124 and 126 are positioned to make the green, blue, and red beams 103, 105, 107 as co-linear as possible (substantially co-linear) before reaching the scanning assembly 130. Most importantly, the dichroic mirrors direct all three beams towards the small high-speed scan mirror. Filter 124 allows the green beam 107 to pass there through, while reflecting the blue beam 105. Filter 126 allows the green beam 107 and blue beam 105 to pass there through, while reflecting the red beam 103. The operation of the system described above is described in detail in U.S. Pat. No. 7,059,523 which is incorporated herein by reference.

The nearly co-linear beams 103, 105, 107 are reflected off a first scan mirror 132 and a second scan mirror 134. One or more additional mirrors (not shown), which may be stationary, may be utilized to direct the beams 103, 105, 107 in the desired direction and/or for image orientation.

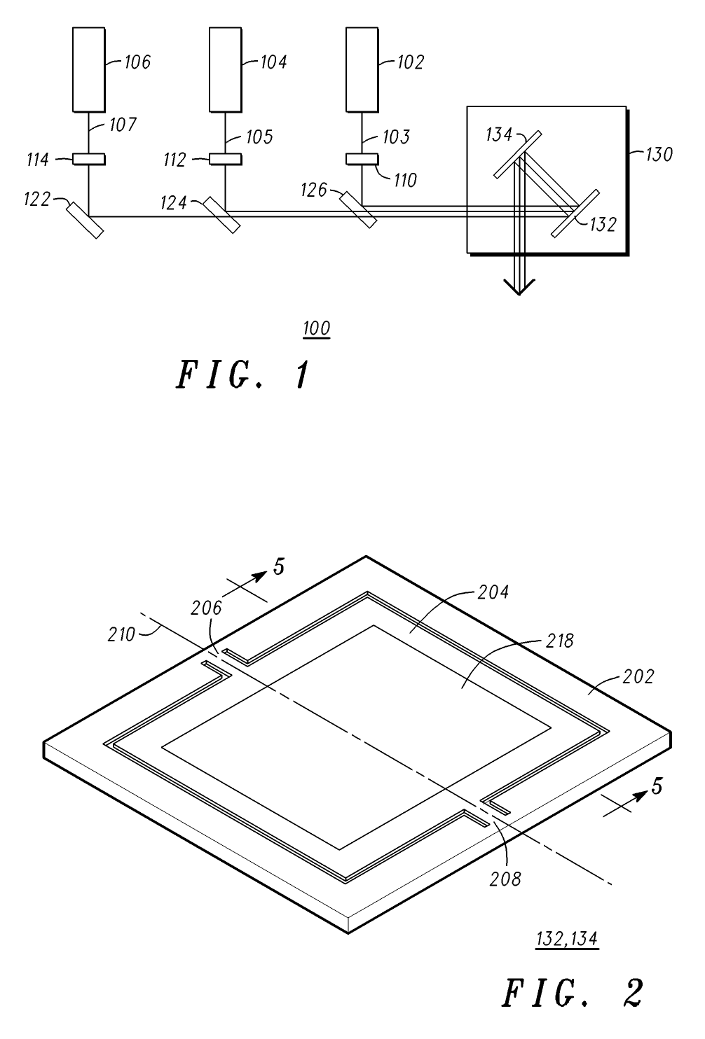

Referring to FIG. 2 and in accordance with a first exemplary embodiment, the scan mirror 132, 134 comprises a moveable frame 202 and an oscillating portion 204. The moveable frame 202 and oscillating portion 204 are fabricated of a one-piece, generally planar, silicon substrate which is approximately 150 microns thick. The frame 202 supports the oscillating portion 204 by means of hinges that includes a pair of co-linear hinge portions 206, 208 extending along a hinge axis 210 and connecting between opposite regions of the oscillating portion 204 and opposite regions of the frame 202. The frame 202 need not surround the oscillating portion 204 as shown. Oscillating portion 204 includes a reflective portion 218 for reflecting the beams 103, 105, 107.

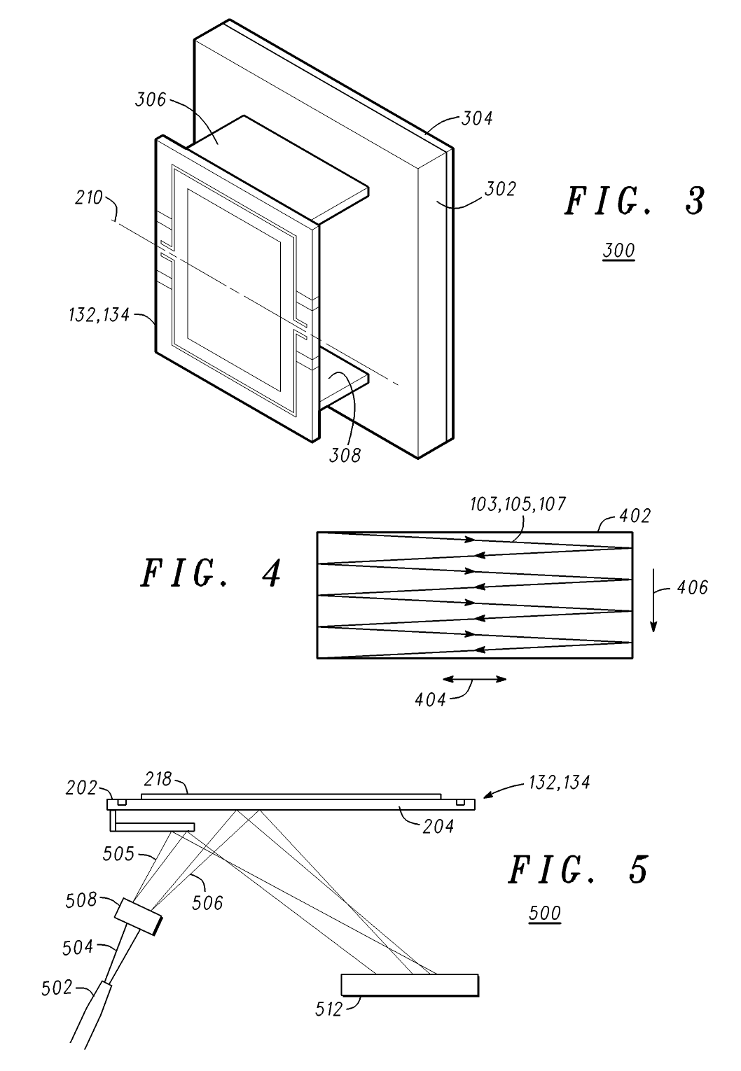

A drive system 300 shown in FIG. 3 includes a high-speed, low electrical power-consuming inertial drive 302 that typically is mounted on a printed circuit board 304. A scan mirror, for example scan mirror 132 or 134, is mounted on the inertial drive 302 by piezoelectric transducers 306, 308 extending perpendicularly between the frame 202 and the inertial drive 302, and on opposed sides of the axis 210. Although only two piezoelectric transducers 306, 308 are shown, additional piezoelectric transducers, such as four, may be used. An adhesive may be used to insure a permanent contact between the one end of each transducer 306, 308 and the frame 202. Each transducer 306, 308 is coupled by solder or conductive epoxy, for example, to the printed circuit board 304 to receive a periodic alternating voltage. The piezoelectric transducers 306, 308 could be mounted on printed circuit boards, ceramic substrates, or any rigid substrate, as long as electrical connections can be made thereto.

One of the scan mirrors, for example scan mirror 132, oscillates to provide a horizontal scan (direction 404) as illustrated on the display 402 in FIG. 4. The other of the scan mirrors, for example scan mirror 134, oscillates to provide a vertical scan (direction 406).

In operation, the periodic alternating voltage causes the respective transducer 306, 308 to alternatively extend and contract in length. When transducer 306 extends, transducer 308 contracts, and vice versa, thereby simultaneously pushing and pulling the frame 202 to twist, or move, about the axis 210. As the frame moves, the oscillating portion 204 reaches a resonant oscillation about the axis 210.

The above described projection system 100, including mirrors 132, 134 and the drive system 300, is preferred; however, any type of projections system and mirror or mirrors may be used with any of the exemplary embodiments described herein.

Referring to FIG. 5, a first exemplary embodiment of a system 500 for determining the position of the oscillating portion 204 (taken along line 5-5 of FIG. 2) at a specific point in time so the lasers 102, 104, 106 may be pulsed in a timely fashion, includes a beam delivery system 502 providing a beam 504 which is split into two beams 505, 506 by a beam splitter 508. The beam delivery system 502 may comprise a laser, or if the laser is at a remote location, mirrors or optical fiber to deliver the beam 504. The beam delivery system 502 is preferably a semiconductor laser, but may be any type of laser, providing the beam 504 having a frequency preferably in the range of 780 to 850 nanometers, preferably a Vertical Cavity Surface Emitting Lased (VCSEL). The beam splitter 508 may be any conventional beam splitter, for example, a prismatic film. The beam 505 is reflected off a stationary mirror 507 (which is shown as being attached to the frame 202, for example) and beam 506 is reflected off of the oscillating portion 204. The beam 506 may be reflected anywhere off of the oscillating portion 204, but preferably is disposed on a side of the oscillating portion 204 opposed to the reflective surface 218. Both reflected beams 505 and 506 are received by a sensor 512. Since the beam 504 from the beam delivery system 502 is diverging, both beams 505, 506 enter in the detector 512 over a fairly large angular deflection. However, since the beams 505, 506 coherently interfere with each other, depending on the angular position of the mirror, constructive and destructive interference is sensed by the detector 512, which changes with deflection angle. Interferometer techniques are used to count the interference fringes to determine the position of the oscillating portion 204 as it oscillates.

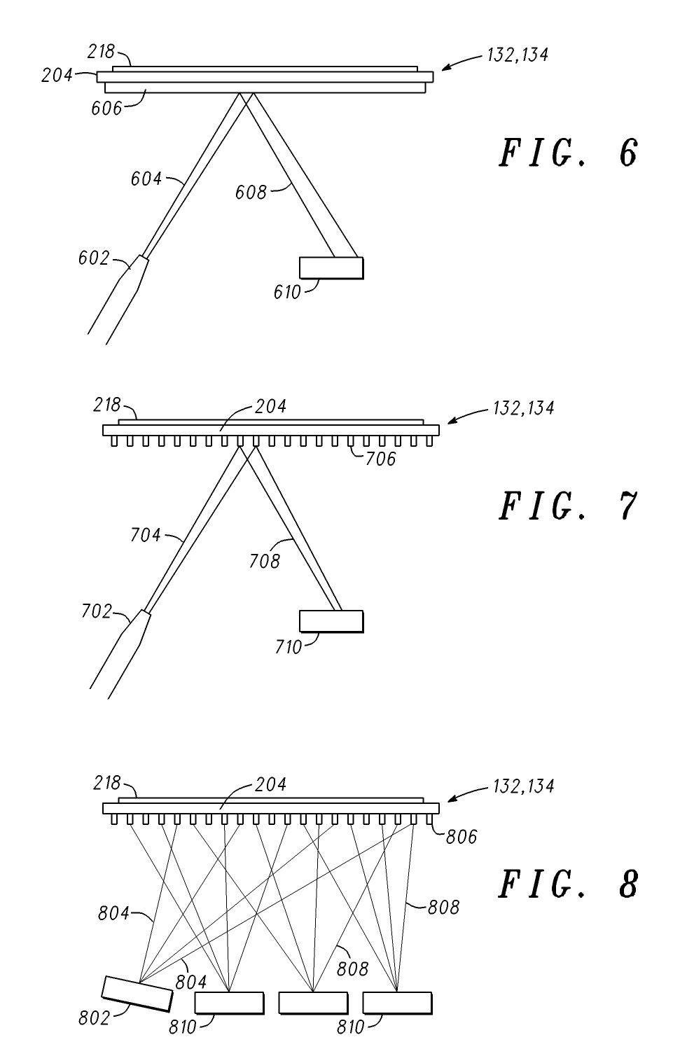

A second exemplary embodiment shown in FIG. 6 includes a beam delivery system 602 providing a beam 604. The beam delivery system 502 may comprise a laser, or if the laser is at a remote location, mirrors or optical fiber to deliver the beam 504. The beam delivery system 602 is preferably a semiconductor laser, but may be any type of laser, providing the beam 604 having a frequency preferably in the range of 780 to 850 nanometers, preferably a Vertical Cavity Surface Emitting Lased (VCSEL). The beam 604 is directed to the optically rough surface 606 disposed on the oscillating portion 204. The optically rough surface 606 may be disposed anywhere on the oscillating portion 204 other than the reflective surface 218, but preferably is disposed on a side of the oscillating portion 204 opposed to the reflective surface 218. Light 608 from the laser beam 604 reflecting off of the speckled surface 606 is received by a sensor or sensor array 610. There is random interference (also known as speckle) due to the reflection and coherent interference from the optically rough backside surface of the scan mirror. That speckle is detected by the detector or detector array 610. From the changing speckle pattern on the detector 610, the movement of the mirror may be determined. This approach requires specialized signal processing algorithms to determine the mirror 132, 134 deflection. This approach is similar to the way some of the optical mice work in determining the motion of the mouse on a rough surface.

A third exemplary embodiment shown in FIG. 7 includes a beam delivery system 702 providing a beam 704. The beam delivery system 502 may comprise a laser, or if the laser is at a remote location, mirrors or optical fiber to deliver the beam 504. The beam delivery system 702 is preferably a semiconductor laser, but may be any type of laser, providing the beam 704 having a frequency preferably in the range of 780 to 850 nanometers preferably a Vertical Cavity Surface Emitting Lased (VCSEL). The beam 704 is directed to a grooved surface 706 disposed on the oscillating portion 204. The grooved surface 706 may be disposed anywhere on the oscillating portion 204 other than the reflective surface 218, but preferably is disposed on a side of the oscillating portion 204 opposed to the reflective surface 218. Light 708 from the laser beam 704 reflecting off of the grooved surface 706 is received by a sensor 710. This exemplary embodiment is very similar to the previous exemplary embodiment, except that instead of a random speckle pattern, a very predictable interference pattern that depends on the groove density is obtained.

A fourth exemplary embodiment shown in FIG. 8 includes a broadband light source 802 providing a light 804. The broadband light source 802 is preferably a light emitting diode, but may be any type of light source, providing the light 804 having a frequency in the range of 500 to 900 nanometers. The light 804 is directed to a grooved surface 806 disposed on the oscillating portion 204. The grooved surface 806 may be disposed anywhere on the oscillating portion 204 other than the reflective surface 218, but preferably is disposed on a side of the oscillating portion 204 opposed to the reflective surface 218. Light 808 from the light source 804 reflecting off of the grooved surface 806 is received by a plurality of sensors 810. Though three sensors 810 are shown, any number of sensors 810 may be used. Even though the LED 702 has a broader optical spectrum, and it is not a coherent light source, there will still be a repeatable random pattern generated on the detector, and therefore, information about the mirror deflection may be obtained.

The advantage of these previous four exemplary embodiments is that there is no requirement for accurate optical alignment and focusing between the source and the detector. This is in contrast with the fifth exemplary embodiment to be described below.

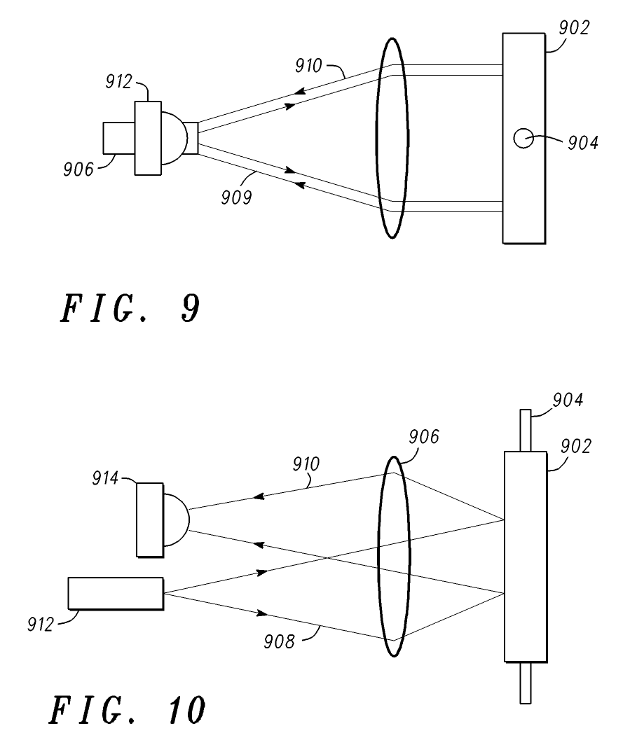

A fifth exemplary embodiment is shown in FIG. 9, a top view, and FIG. 10, a side view, and includes an oscillating mirror 902 suspended on a torsion hinge 904. A lens 906 focuses the beams 908, 910 from a light source 912 and to a slit-apertured detector 914. The detector 914 senses a sharp light pulse when the mirror surface is exactly perpendicular to the direction of the collimated beam 908, 910 from the lens 906.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An image projection system comprising:
a first laser providing a first beam;
a scan mirror comprising:
a frame;
a first oscillating portion disposed contiguous to the frame and including a first reflective portion capable of reflecting the first beam to provide an image; and
a second reflective portion;
a light source providing light to the second reflective portion; and
circuitry analyzing the light reflected from the second reflective portion to determine the position of the first oscillating portion.

2. The image projection system of claim 1 wherein the circuitry includes a photo-sensor for detecting the light prior to being analyzed.

3. The image projection system of claim 1 wherein the light source comprises a second laser, the light comprises a second beam, and the second reflective portion comprises a rough surface.

4. The image projection system of claim 3 wherein the reflected light comprises a reflected second beam exhibiting coherent interference.

5. The image projection system of claim 4 wherein the rough surface causes the light to create a speckle pattern.

6. The image projection system of claim 3 wherein the reflected light comprises a reflected second beam exhibiting a predictable interference pattern with the first beam.

7. The image projection system of claim 6 wherein the rough surface comprises a plurality of grooves.

8. The image projection system of claim 1 wherein the light source comprises a broadband light source and the second reflective portion comprises a plurality of grooves.

9. The image projection system of claim 8 wherein the circuitry comprises a plurality of detectors for analyzing the reflected light as a repeatable random pattern.

10. The image projection system of claim 1 further comprising a third reflective portion stationary with respect to the frame, and a beam splitter, wherein the light source comprises a second laser, the light comprises a second beam, the beam splitter dividing the second beam into third and fourth beams, and the circuitry analyzing the third beam reflected from the second reflective portion and the fourth beam reflected from the third reflective portion.

11. The image projection system of claim 10 wherein the circuitry comprises an interferometer for sensing interference fringes of coherent interference created by the third and fourth beams.

12. An image projection system comprising:
a laser providing a first laser beam;
a light source providing light;
a mirror comprising:
a drive apparatus;
a frame moveable in response to the drive apparatus;
an oscillating portion disposed contiguous to the frame and oscillating in response to the movement of the frame;
a first reflective portion disposed on the oscillating portion for reflecting the first laser beam; and
a second reflective portion for reflecting the light;
circuitry analyzing the reflected light; and
control circuitry synchronizing a pulsing of the first laser beam with the position of the oscillating portion based on the analyzed reflecting light.

13. The image projection system of claim 12 wherein the light source comprises a second laser, the light comprises a second beam, and the second reflective portion comprises a rough surface on a second portion of the oscillating portion.

14. The image projection system of claim 13 wherein the reflected light comprises a reflected second beam exhibiting coherent interference.

15. The image projection system of claim 14 wherein the rough surface causes the light to create a speckled pattern.

16. The image projection system of claim 13 wherein the reflected light comprises a reflected second beam exhibiting a predictable interference pattern.

17. The image projection system of claim 16 wherein the rough surface comprises a grooved surface comprises a plurality of grooves.

18. The image projection system of claim 12 wherein the light source comprises a broadband light source and the second reflective portion comprises a plurality of grooves on a second portion of the oscillating portion.

19. The image projection system of claim 18 wherein the circuitry comprises a plurality of detectors for analyzing the reflected light as a repeatable random pattern.

20. The image projection system of claim 12 further comprising a third reflective portion stationary and a beam splitter, wherein the second reflective portion comprises a second portion of the oscillating portion, the light source comprises a second laser, the light comprises a second beam, the beam splitter divides the second beam into third and fourth beams, and the circuitry analyzing the third beam reflected from the second reflective portion and the fourth beam reflected from the third reflective portion.

21. The image projection system of claim 20 wherein the circuitry comprises an interferometer for sensing interference fringes of coherent interference created by the third and fourth beams.
